(19) United States
(12) Patent Application Publication
(10) Pub. No.: US 2017/0243154 A1
(43) Pub. Date: Aug. 24, 2017

(54) SYSTEMS AND METHODS FOR INDICATING WORKER TASKS AT A RETAIL SALES FACILITY

(71) Applicant: Wal-Mart Stores, Inc., Bentonville, AR (US)

(72) Inventors: Marc A. Fletter, Bentonville, AR (US); Matthew A. Jones, Bentonville, AR (US)

(21) Appl. No.: 15/437,881

(22) Filed: Feb. 21, 2017

Related U.S. Application Data
(60) Provisional application No. 62/298,223, filed on Feb. 22, 2016.

(51) Int. Cl. G06Q 10/06; G06K 7/10

(52) U.S. Cl. CPC G06Q 10/063118; G06K 7/10297; G06K 7/10861

(57) ABSTRACT

In some embodiments, methods and systems of indicating worker tasks associated with products at a retail sales facility. An electronic scanning device scans products stored at the retail sales facility and communicates with an electronic inventory management device. The electronic inventory management device is configured to determine, based on at least electronic data obtained during a scan of the products stored at the retail sales facility via the electronic scanning device, a physical size of each of the scanned products and a sequential order of the scanning of the products. The electronic inventory management device can then estimate, based on at least a correlation of the physical size of each of the scanned products and the sequential order of the scanning of the products, a physical location of the scanned products relative to one another.

### RELATED APPLICATIONS

This application claims the benefit of U.S. Provisional Application No. 62/298,223, filed Feb. 22, 2016, which is incorporated herein by reference in its entirety.

### TECHNICAL FIELD

This invention relates generally to indicating worker tasks at a retail sales facility and, in particular, to displaying worker tasks associated with products at a retail sales facility.

### BACKGROUND

Workers at retail sales facilities such as large department stores typically perform different tasks related to inventory management and stocking. One such task revolves around scanning each product stored in a stock of a retail sales facility room to determine what tasks are to be performed for that product. For example, a worker may walk along a shelf in a stock room where overstock products are stored, and use a hand-held scanner to scan all of the products located on the shelf, or to scan all of the products located in one or more storage bins in the stock room.

The scanned products may include an individual item or a case containing multiple items. To scan a product (e.g., a case), the worker typically places the scanner in proximity to identifying indicia (e.g., bar code) of the product as the worker is standing next to the product or walking past the product. In response to the scanning of the product by the worker, the scanner typically sends the obtained barcode information to a server that runs the inventory management application on the scanner and stores an inventory management database, after which the server may transmit a worker task associated with the scanned product to the scanner which in turn displays the worker task.

One disadvantage of such systems is that the process of scanning the product using the scanner may be completed in a quick hand motion, while the communication between the scanner and server to ultimately display the worker task associated with the scanned product on the scanner often takes more time. Accordingly, the worker can scan an entire bin or shelf full of products in the stock room faster than the scanner can display a task associated with each of the products that the worker scanned. As such, when a worker task is displayed for the worker on the scanner, it is often difficult for the worker to determine which product the task refers to.

### BRIEF DESCRIPTION OF THE DRAWINGS

Disclosed herein are embodiments of systems, apparatuses and methods pertaining to systems and methods of indicating worker tasks associated with products at a retail sales facility. This description includes drawings, wherein:

FIG. 1 is a diagram of a system of indicating worker tasks associated with products at a retail sales facility in accordance with some embodiments.

FIG. 2 is a functional diagram of an electronic inventory management device in accordance with several embodiments.

FIG. 3 is a flow diagram of a process of indicating worker tasks associated with products at a retail sales facility in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common, well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, this application describes systems and methods of indicating worker tasks associated with products at a retail sales facility. After a worker scans one or more products stored at the retail sales facility, a physical size and a sequential order of the scanning of the products is determined, and based on a correlation of the physical size of the products and the sequential order in which the products were scanned, a physical location of the scanned products relative to each other is determined, enabling an indication of a worker task for each product.

In one embodiment, a system for indicating worker tasks associated with products at a retail sales facility includes an electronic scanning device configured to scan identifying indicia of a plurality of products stored at the retail sales facility and an electronic inventory management device in communication with the electronic scanning device and including a control unit including a processor. The control unit is configured to determine, based on at least electronic data obtained during a scan of the identifying indicia of the products stored at the retail sales facility via the electronic scanning device, a physical size of each of the scanned products and a sequential order of the scanning of the products and to estimate, based on at least a correlation of the physical size of each of the scanned products and the sequential order of the scanning of the products, a physical location of the scanned products relative to one another.

In another embodiment, a method of indicating worker tasks associated with products at a retail sales facility includes: scanning, via an electronic scanning device, identifying indicia of a plurality of products stored at the retail sales facility; determining, via an electronic inventory management device including a processor and based on at least electronic data obtained during the scanning step, a physical size of each of the scanned products and a sequential order of the scanning of the products; and estimating, using the electronic inventory management device, based on at least a correlation of the physical size of each of the scanned products and the sequential order of the scanning of the products, a physical location of the scanned products relative to one another.

In yet another embodiment, a system for indicating worker tasks associated with products at a retail sales facility includes: means for scanning, via an electronic scanning device, identifying indicia of a plurality of products stored at the retail sales facility; means for determining, via an electronic inventory management device including a processor and based on at least electronic data obtained during the scanning step, a physical size of each of the scanned products and a sequential order of the scanning of the products; and means for estimating, using the electronic inventory management device, based on at least a correlation of the physical size of each of the scanned products and the sequential order of the scanning of the products, a physical location of the scanned products relative to one another.

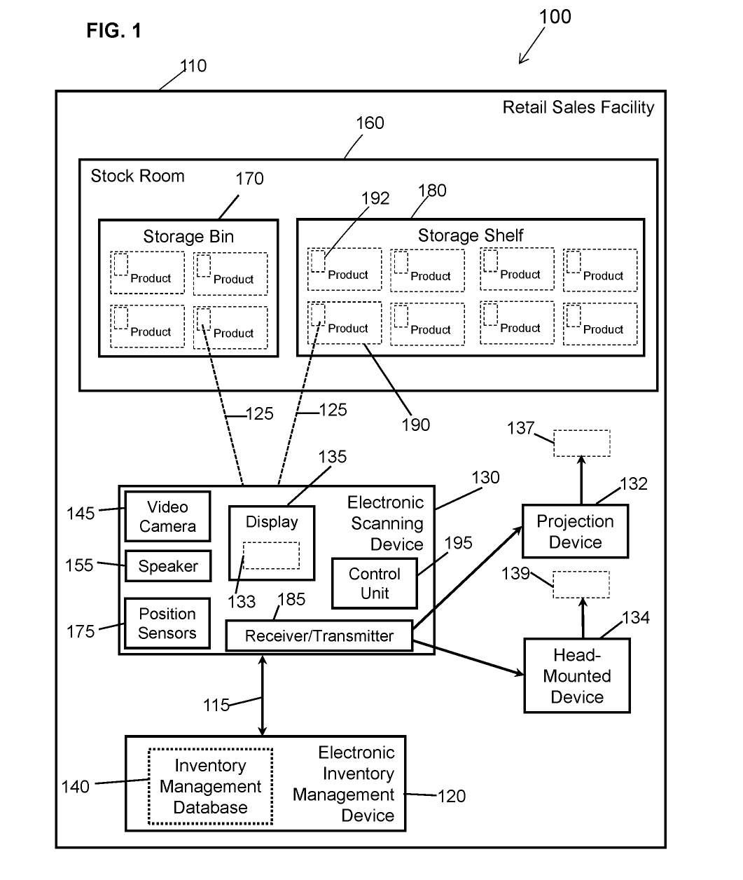

FIG. 1 shows an embodiment of a system 100 for indicating worker tasks associated with products 190 at a retail sales facility 110. The retail sales facility 110 may be any place of business (e.g., a brick-and-mortar store) where consumer products 190 are stocked and/or sold. The term “product” or “products” will be understood herein to refer to a case containing multiple units of an item and/or to an individual item that is not in a case. The term “worker task” refers to an action taken by a worker with respect to a product.

The exemplary system 100 in FIG. 1 includes an electronic inventory management device 120 that facilitates management of the inventory of products 190 at the retail sales facility 110 and the indicating of worker tasks associated with products 190 at the retail sales facility 110. More specifically, the electronic inventory management device 120 is configured to store and manage electronic data associated with the products 190 at the retail sales facility 110 as well as to generate and/or receive and/or transmit worker tasks previously performed or scheduled to be performed in association with the products 190 by workers at the retail sales facility 110.

The electronic inventory management device 120 in FIG. 1 may be a stationary or portable electronic device, for example, a desktop computer, a laptop computer, a tablet, a mobile phone, or any other electronic device including a processor-based control circuit (i.e., control unit) and configured for data entry and one-way and/or two-way communication (e.g., via communication channel 115) with another device located at the retail sales facility 110 (e.g., electronic scanning device 130), or with another device at a location remote to the retail sales facility 110 (e.g., a regional and/or central server) that is configured for two-way communication with the electronic inventory management device 120 at the retail sales facility 110.

The exemplary electronic inventory management device 120 shown in FIG. 1 includes an inventory management database 140 configured to store electronic information associated with the products 190 at the retail sales facility 110 and the worker tasks associated with the products 190. The inventory management database 140 may store electronic data including but not limited to: identification data associated with products 190 stored at the retail sales facility 110; time stamp data indicating a scan of a product 190 by a worker at the retail sales facility 110 when performing a worker task; data indicating completion of a worker task by one or more workers at the retail sales facility 110 with respect to the product 190; and data indicating one or more worker tasks scheduled for one or more workers with respect to the product 190. The inventory management database 140 may also store electronic data pertaining to, for example, size, weight, shape, and/or other parameters associated with each of the products 190 stored at the retail sales facility, as well as relative positions of the products 190 stored at the retail sales facility 110.

The inventory management database 140 may be stored, for example, on non-volatile storage media (e.g., a hard drive, flash drive, or removable optical disk) internal or external relative to the electronic inventory management device 120. It will be appreciated that the inventory management database 140 does not have to be incorporated into or physically coupled to the electronic inventory management device 120, but may be stored on one or more servers remote to the retail sales facility 110 and in communication with the electronic inventory management device 120. In some embodiments, the electronic data stored in the inventory management database 140 may be entered into the electronic inventory management device 120 by a worker at the retail sales facility 110. Alternatively, the electronic data may be transmitted to the inventory management database 140 from another device, for example, a server remote to the retail sales facility 110, or an electronic scanning device 130, discussed in more detail below.

In the embodiment shown in FIG. 1, the system 100 includes an electronic scanning device 130 in two-way communication with the electronic inventory management device 120 over a communication channel 115 (which may be a wired or wireless channel). The electronic scanning device 130 may obtain electronic data associated with the scanned product 190 by communicating via a communication channel 125 (e.g., radio waves) with a unique identifying indicia 192 (e.g., barcode, RFID, SKU, or the like) on an exterior of the product 190.

The electronic scanning device 130 may be a hand-held device that may be used by a worker at the retail sales facility 110 to scan one or more products 190 and/or to input electronic data relating to worker tasks performed in association with the products 190. Examples of such electronic scanning devices 130 may include, but are not limited to barcode (e.g., UPC, EAN, GTIN12, GTIN 13, or the like) readers, quick response (QR) code readers, optical readers, radio frequency identification (RFID) readers, stock keeping unit (SKU) readers, near field communication (NFC) readers, video capture-enabled devices (e.g., cameras, smartwatches, glasses, or the like) electronic tablets, cellular phones, or the like mobile electronic devices. Alternatively, the electronic scanning device 130 may be a stationary electronic scanner installed in the stock room 160 and configured to scan identifying indicia 192 of the products 190 stored in the stock room 160 without the necessity of being placed in close proximity to the products 190.

In some embodiments, the above-described exemplary electronic data associated with the products 190 and worker tasks at the retail sales facility 110 may be recorded in the inventory management database 140 as a result of a task performed by a worker at a retail sales facility 110 with respect to a product 190. For example, the worker may enter a worker task into the electronic scanning device 130 indicating that a product 190 has been received at the retail sales facility 110 and is being unloaded from a delivery truck. Also, the worker may scan a product 190 using the electronic scanning device 130 when binning the product 190 into a bin 170 in the stock room 160, when picking the product 190 from the bin 170 in the stock room 160, when placing the product 190 onto a shelf 180 in the stock room 160, and when picking the product 190 off the shelf 180 in the stock room 160. In some embodiments, at least some of the electronic data stored in the inventory management database 140 may be transmitted to the electronic inventory management device 120 from a server remote to the retail sales facility 110, for example, a server located at a regional center or server storage location associated with the retail sales facility 110.

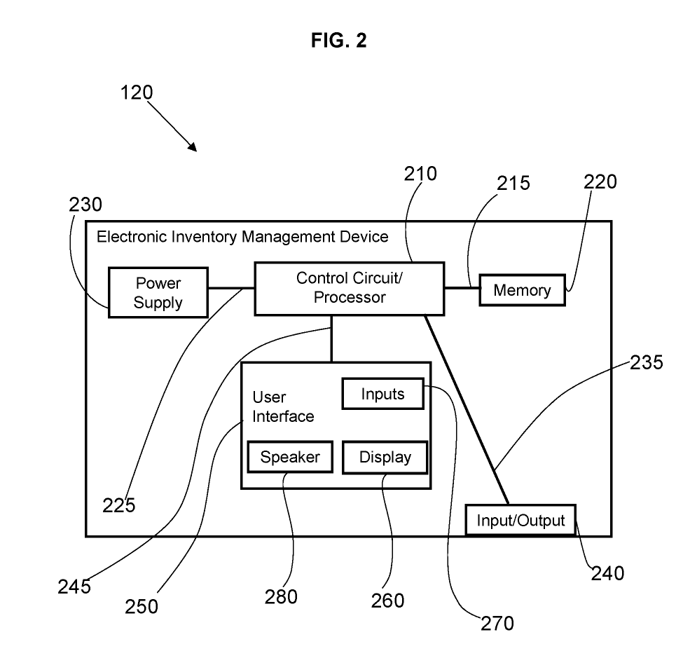

In the embodiment shown in FIG. 2, the processor-based control unit 210 of the electronic inventory management device 120 is electrically coupled via a connection 245 to a user interface 250, which may include a visual display or display screen 260 (e.g., LED screen) and/or button input 270 that provide the user interface 250 with the ability to permit a user to manually control the electronic inventory management device 120 by inputting commands, for example, via touch-screen and/or button operation or voice commands. The display screen 260 can also permit the user to see various menus, options, and/or alerts displayed by the electronic inventory management device 120. The user interface 250 of the electronic inventory management device 120 may also include a speaker 280 that may provide audible feedback (e.g., alerts) to the user.

In some embodiments, the control unit 210 of the electronic inventory management device 150 of FIG. 2 is configured (e.g., by programming the processor), based on data received from the electronic scanning device, to identify each of the products 190 scanned by a worker using the electronic scanning device 130, and to determine a physical size of each of the identified products 190. For example, in embodiments, where the inventory management database 140 stores electronic data indicating a physical size in associated with each of the products 190 present at (or to be delivered to) the retail sales facility 110, the control unit 210 may be programmed to obtain such size data from the inventory management database 140 after receiving an identification (e.g. barcode data) of a scanned product 190 from the electronic scanning device 130.

In some embodiments, the control unit 210 is programmed, based on sensor data (e.g., position sensor data) received from the electronic scanning device, to estimate a relative distance, altitude, and angle of the electronic scanning device 130 relative to the identifying indicia 192 of each of the scanned products 190. For example, after a worker scans a product 190 using the electronic scanning device 130, the electronic scanning device 130 is configured to obtain position data via one or more position sensors 175 of the electronic scanning device 130, and to send a signal (e.g., via a Wi-Fi or cellular network) to the electronic inventory management device 120 including the electronic sensor data indicating a position of the electronic scanning device 130 relative to the position of the identifying indicia 192 on each of the scanned products 190.

The control unit 210 of the electronic inventory management device 120 is configured to determine the relative position (e.g., distance, angle, and height) of the electronic scanning device 130 relative to the product 190 based on the sensor data received from the electronic scanning device 130. In some embodiments, the identifying indicia 192 is placed in an identical location (e.g., upper left corner of the front face) on each of the products 190 enabling the control unit 210 to consistently and accurately determine the precise distance from the electronic scanning device 130 to the scanned product 190 based on the known size of the product 190 (obtainable from the inventory management database 140), and based on the known location of the identifying indicia 192 on the product 190 and the relative distance and altitude of the electronic scanning device 130 and the identifying indicia 192 on the product 190.

In some embodiments, the electronic scanning device 130 generates a time stamp when the worker scans the identifying indicia 192 on each of the scanned products 190 using the electronic scanning device 130. The electronic scanning device 130 includes a transmitter 185 configured to transmits electronic data representing the time stamp to the electronic inventory management device 120. The control unit 210 of the electronic inventory management device 120 is programmed to determine a sequential order of the scanning of the products 190 by the worker based on the time stamp received from the electronic scanning device 130. In other words, the control unit 210, upon processing a number of time stamps for a number of scanned products 190, can determine the first-to-last order in which the products 190 were scanned by the worker.

The control unit 210 of the electronic inventory management device 120 is programmed to estimate, based on a correlation of the physical size of each of the scanned products 190 (e.g., obtained from the inventory management database 140) and the sequential order of the scanning of the products 190 (e.g., obtained from the electronic scanning device 130), a physical location of the scanned products 190 relative to one another in any given storage space (e.g., stock room 160, sales floor, unloading area, etc.). As discussed above, the inventory management database 140 may store electronic data indicating the worker tasks associated with the products 190. In some embodiments, the control unit 210 of the electronic inventory management device 120 is programmed to generate, based on the estimated relative location of the scanned products 190 by the control unit 210, electronic data representing a visual output including at least one worker task associated with each of the scanned products 190.

In some embodiments, the electronic inventory management device 120 can transmit this generated visual output data to the electronic scanning device 130, which is in turn configured to generate and display a visual output 133 indicating the worker tasks associated with the scanned products 190 to a worker at the retail sales facility 110. The visual output 133 may include a graphical representation of the scanned products 190 and indicating the relative locations of all of the scanned products 190 as well as a graphical overlay indicating the tasks associated with the scanned products 190. In some embodiments, as shown in FIG. 1, the electronic scanning device 130 may include a speaker 155 for providing the worker at the retail sales facility 110 with audible instructions relating to the tasks to be performed for each of the scanned products 190.

In the embodiment shown in FIG. 1, the electronic scanning device 130 includes a display screen 135 and a video camera 145. The video camera 145 of the electronic scanning device is configured to acquire a (real-time) video feed or a still photograph of the scanned products 190 as the worker is scanning the products 190 in the stock room 160 (or another location) of the retail sales facility 110. In some embodiments, the video camera 145 of the electronic scanning device 130 may capture the identifying indicia 192 of the products 190 in real time to facilitate the identification of the products 190 by the electronic scanning device 130 and to provide real-time monitoring of the performance by the worker of the worker tasks associated with the products 190 as indicated in the visual output 133 generated by the electronic scanning device 130.

The electronic scanning device 160 of FIG. 1 also includes a receiver/transmitter 185 configured to transmit the video feed or photographic snap shots or other electronic data associated with a visual output (e.g., visual output 137, visual output 139, etc.) to other electronic devices, for example, a projection device 132, a head-mounted device 134, or the electronic inventory management device 120. In some embodiments, the control unit 210 of the electronic inventory management device 120 is programmed to correlate the video feed received by the video camera 145 indicating the physical location and size of the products 190 being scanned to facilitate the generation (e.g., by the control unit 210 of the electronic inventory management device 120 or the processor of the electronic scanning device 130) of an graphical overlay such that a worker task associated with each of the scanned products 190 is overlaid over the respective product 190.

In some embodiments, the visual output 133 includes a virtual graphical representation, on the display screen 135, of the scanned products 190 and their physical location relative to one another graphically overlaid with worker tasks associated with each of the scanned products 190. In other embodiments, the visual output 133 includes a live video feed generated by the video camera 145 and displayed on the display screen 135 to show the scanned products 190 and their physical location relative to one another with a graphical overlay over the video feed to visually indicate the worker tasks associated with each of the scanned products 190 on the display screen 135. In such embodiments, the worker would look to the visual output 133 on the display screen 135 of the electronic scanning device 130 for an indication of a task to be performed with respect to each of the products 190 shown on the display screen 135. The video camera 145 may be coupled with anti jitter technology to stabilize the projected overlay to facilitate ease of reading of the visual output 133 and/or the graphical overlay by the worker.

In some embodiments, the electronic scanning device 130 is configured to generate a virtual visual output 139 that includes a graphical representation of all the scanned products 190 with a graphical overlay indicating the tasks associated with each of the scanned products 190 in a way that is visible to a worker via an optical device. In some embodiments, as shown in FIG. 1, the electronic scanning device 130 transmits electronic data representing the visual output 139 to a head-mounted device 134 of a worker, which may include an optical display and an earpiece (e.g., Google Glass® or the like), such that the visual output 139 of the scanned products 190 including the graphical overlay indicating the tasks to be performed by the worker with respect to all of the scanned products 190 is presented to the worker on or via the head-mounted device 134.

In some embodiments, as shown in FIG. 1, the electronic scanning device 130 is configured to generate a virtual visual output 137 that includes a graphical representation of all the scanned products 190 with a graphical overlay indicating the tasks associated with each of the scanned products 190 in a way that is visible to a worker via a projection device 132. In the embodiment shown in FIG. 1, the electronic scanning device 130 transmits electronic data representing the visual output 137 to the projection device 132 which may in turn project a virtual graphical overlay directly on each of the scanned products 190 such that when the worker looks at the scanned products 190 on the shelf 180 or in a storage bin 170, the graphical overlay of the visual output 137 indicates a worker task for each of the scanned products 190 directly on the physical products 190.

With reference to FIGS. 1-3, one method 300 of operation of the system 100 for indicating worker tasks associated with products 190 at a retail sales facility 110 will now be described. The method 300 is described in the context of the system of FIG. 1 by way of example only, and it will be appreciated that embodiments of the method 300 may be implemented not only in the system 100, but in other systems.

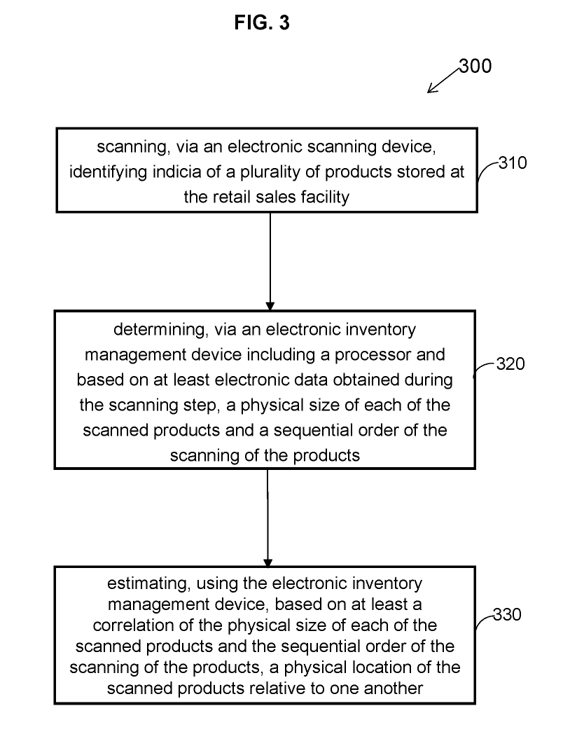

In the exemplary method 300 illustrated in FIG. 3, a worker (e.g., stock room 160 associate) scans an identifying indicia 192 of one or more products 190 stored in the stock room 160 of the retail sales facility (step 310). It will be appreciated that such scanning of products 190 may occur in the stock room 160, in a receiving area where products 190 delivered to the retail sales facility 110 are received and unloaded, on the sales floor of the retail sales facility 110, and/or in any other area of the retail sales facility 110 where products 190 may be stored at the retail sales facility 110.

Upon scanning of a product 190 by a worker using the electronic scanning device 130, the electronic scanning device 130, via one or more position sensors 175, captures one or more of distance, altitude, and angle values representing the distance, height, and angle, respectively, of electronic scanning device 130 relative to the scan surface (e.g., identifying indicia 192 such as barcode) on the product 190 to be used to derive a scanning vector. The electronic scanning device 130 can then transmit the position sensor data and the product 190 identification data obtained from the scanning of the identifying indicia 192 of the products 190 to the electronic inventory management device 120.

Based at least on the electronic data (e.g., barcode or RFID data) received from the electronic scanning device 130 after the scanning of the products 190, the control unit 210 of the electronic inventory management device 120 determines a physical size of each of the scanned products 190 and a sequential order of the scanning of the products 190 (step 320). As explained above, the physical size of the scanned products 190 may be obtained by the electronic inventory management device 120 from the inventory management database 140, and the sequential order of the scanning of the products 190 may be obtained from time stamp data received by the electronic inventory management device 120 from the electronic scanning device 130.

After the physical size and sequential order of the scanning of the products 190 is determined by the control unit 210 of the electronic inventory management device 120, the control unit 210 is programmed to generate an output estimating, based on at least a correlation of the physical size of each of the scanned products 190 and the sequential order of the scanning of the products 190, a physical location of the scanned products 190 relative to one another (step 330).

In some embodiments, after the control unit 210 of the electronic inventory management device 120 retrieves from the inventory management database 140 electronic data representing the physical size of each of the scanned products 190, the control unit 210 is programmed to correlate the physical size of each of the products 190 with the position sensor data and time stamp data obtained from the electronic scanning device 130. Such correlation processing by the control unit 210 permits the control unit 210 calculate the location of the products 190 relative to each other and the sequential order of the scanning of the products 190 by the worker.

With reference to FIG.1, after the physical locations of the scanned products 190 relative to one another are determined by the control unit 210 of the electronic inventory management device 120, the control unit 210 is programmed to generate electronic data representing a graphical overlay indicating the worker tasks associated with each of the scanned products 190. Alternatively, the electronic inventory management device 120 may simply transmit the worker tasks associated with each of the scanned products 190 to the electronic scanning device 130 and the electronic scanning device 130, via a processor-based control unit 195, can generate a virtual graphical display of the scanned products 190 and the graphical overlay indicating the worker tasks associated with each of the scanned products 190 based on the worker task data received from the electronic inventory management device 120.

As described above, the electronic scanning device 130 is configured to generate a visual output 133, 137, and/or 139 including the aforementioned graphical overlay indicating a worker task for each of the products 190 scanned by the worker. As discussed above, a visual output 133 according to some embodiments may be displayed on the display screen 135 of the electronic scanning device 130, either as a virtual representation of the products 190 and a virtual overlay indicating the tasks associated with the products 190, or as a live video feed or a snap photograph of the products 190 (e.g., via the camera 145 of the electronic scanning device 130) overlaid by a virtual graphical overlay indicating the tasks associated with the products 190.

A visual output 139 according to some embodiments may be generated by a head-mounted device 134 of a worker, after receiving electronic data including the relative positions of the products 190 and the graphical overlay indicating the tasks associated with the products 190 from the electronic scanning device 130. Notably, the visual output 139 may be generated on an optical display of the head-mounted device 134, or in a virtual space (e.g., head-up display or the like) such that the head-mounted device 134 enables the worker to see the visual output 139.

A visual output 137 according to some embodiments may be generated by a projection device 132, after receiving electronic data including the relative positions of the products 190 and the graphical overlay indicating the tasks associated with the products 190 from the electronic scanning device 130. Notably, while the projection device 132 is illustrated as a separate physical device in FIG. 1, the electronic scanning device 130 according to some embodiments may physically incorporate a projection device configured to generate the visual output 137 either directly on the physical products 190 or in a virtual space.

In some embodiments, when the electronic scanning device 130 detects that the worker deviated from the worker tasks indicated via the graphical overlay of the visual output (133, 137, or 139), the control unit 210 of the electronic inventory management device 120 (or the processor-based control unit 195 of the electronic scanning device 130) is programmed to correlate the location of the products 190 remaining in the stock room 190 and still having scheduled worker tasks associated with the relative to the physical location of the products 190 in the original worker task-indicating graphical overlay generated by the control unit 210. Based on this correlation, the control unit 210 (or the processor-based control unit 195 of the electronic scanning device 130) calculates and generates a modified graphical overlay indicating the worker tasks for the remaining scanned products 190. The control unit 210 may then transmit the modified graphical overlay data to the electronic scanning device 130 (or the electronic scanning device 130 may generate modified graphical overlay data) such that, despite the deviation from the initial worker task indication, the worker may resume working the products 190 as determined by the control unit 210.

The systems and methods described herein provide for efficient and intuitive indicating of worker tasks associated with products stored at a retail sales facility. Displaying instructions to workers in association with each product advantageously provides for more efficient retrieval of the products from the stock room and reduces instances where worker tasks are performed for the wrong products. Accordingly, the systems and methods described herein advantageously improve worker efficiency and provide for significant cost savings to the retail sales facilities.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for indicating worker tasks associated with products at a retail sales facility, the system comprising:
an electronic scanning device configured to scan identifying indicia of a plurality of products stored at the retail sales facility;
an electronic inventory management device in communication with the electronic scanning device and including a control unit including a processor, the control unit being configured to:
determine, based on at least electronic data obtained during a scan of the identifying indicia of the products stored at the retail sales facility via the electronic scanning device, a physical size of each of the scanned products and a sequential order of the scanning of the products; and
estimate, based on at least a correlation of the physical size of each of the scanned products and the sequential order of the scanning of the products, a physical location of the scanned products relative to one another.

2. The system of claim 1, wherein the identifying indicia comprises at least one of a barcode, an optical code, and a radio frequency identification (RFID) tag located on each of the products, and wherein the electronic scanning device includes at least one of a radio frequency identification (RFID) reader, an optical reader, and a barcode reader.

3. The system of claim 1, wherein the control unit is further configured to estimate a distance from the electronic scanning device to the identifying indicia of each of the scanned products and estimate an angle of the electronic scanning device relative to the identifying indicia of each of the scanned products.

4. The system of claim 3, wherein the electronic scanning device is configured to send a wireless signal to the electronic inventory management device, the wireless signal including electronic data indicating a position of the electronic scanning device and a position of the identifying indicia of each of the scanned products.

5. The system of claim 1, wherein the control unit is further configured to obtain a time stamp generated when each of the products is scanned using the electronic scanning device and obtain identifying information associated with each of the scanned products based on the scanned identifying indicia.

6. The system of claim 5, wherein the control unit is further configured to determine the physical size of each of the scanned products based on the identifying information and determine the sequential order of the scanning of the products based on the time stamp.

7. The system of claim 1, wherein the electronic scanning device is configured to generate, based on the estimate by the control unit, a visual output including at least one worker task associated with each of the scanned products.

8. The system of claim 7, wherein the visual output is a graphical output on a display screen of the electronic scanning device and comprises:
a representation of the scanned products and their physical location relative to one another and at least one worker task associated with each of the scanned products; and
a real time video camera feed of the scanned products indicating the physical location of the scanned products relative to one another and including an overlay indicating the at least worker task associated with each of the scanned products.

9. The system of claim 7, wherein the visual output is a projected output and comprises:
a virtual spatial representation of the scanned products and their physical location relative to one another and the at least one worker task associated with each of the scanned products; and
a virtual overlay on the scanned products indicating the at least worker task associated with each of the scanned products.

10. The system of claim 9, further comprising a projection device in communication with the electronic scanning device, and wherein the electronic scanning device is configured to generate a signal including the generated projected output and transmit the signal to the projection device, and wherein the projection device is configured to project the generated projected output based on the signal received from the electronic scanning device.

11. A method of indicating worker tasks associated with products at a retail sales facility, the method comprising:
scanning, via an electronic scanning device, identifying indicia of a plurality of products stored at the retail sales facility;
determining, via an electronic inventory management device including a processor and based on at least electronic data obtained during the scanning step, a physical size of each of the scanned products and a sequential order of the scanning of the products; and
estimating, using the electronic inventory management device, based on at least a correlation of the physical size of each of the scanned products and the sequential order of the scanning of the products, a physical location of the scanned products relative to one another.

12. The method of claim 11, wherein the identifying indicia comprises at least one of a barcode, an optical code, and a radio frequency identification (RFID) tag located on each of the products, and wherein the scanning step further comprises scanning each of the products using at least one of a radio frequency identification (RFID) reader, an optical reader, and a barcode reader incorporated into the electronic scanning device.

13. The method of claim 11, wherein the determining step further comprises estimating a distance from the electronic scanning device to the identifying indicia of each of the scanned products and estimating an angle of the electronic scanning device relative to the identifying indicia of each of the scanned products.

14. The method of claim 13, wherein the scanning step further comprises sending a wireless signal from the electronic scanning device to the electronic inventory management device, the wireless signal including electronic data indicating a position of the electronic scanning device and a position of the identifying indicia of each of the scanned products.

15. The method of claim 11, wherein the determining step further comprises obtaining, at the electronic inventory management device, a time stamp generated when scanning of each of the scanned products and identifying information associated with each of the scanned products based on the scanned identifying indicia.

16. The method of claim 15, wherein the determining step further comprises determining the physical size of each of the scanned products based on the identifying information and determining the sequential order of the scanning of the products based on the time stamp.

17. The method of claim 11, further comprising generating, based on the determining step, a visual output including at least one worker task associated with each of the scanned products.

18. The method of claim 17, wherein the generating step further includes generating the visual output as a graphical output on a display screen of the electronic scanning device, the graphical output comprising:
a representation of the scanned products and their physical location relative to one another and at least one worker task associated with each of the scanned products; and
a real time video camera feed of the scanned products indicating the physical location of the scanned products relative to one another and including an overlay indicating the at least worker task associated with each of the scanned products.

19. The method of claim 17, wherein the generating step further includes generating the visual output as a projected output, the projected output comprising:
a virtual spatial representation of the scanned products and their physical location relative to one another and the at least one worker task associated with each of the scanned products; and
a virtual overlay on the scanned products indicating the at least worker task associated with each of the scanned products.

20. The method of claim 19, further comprising generating a signal including the generated projected output, transmitting the signal to a projection device configured to project the generated projected output, and projecting the generated projected output from the projection device.

21. A system for indicating worker tasks associated with products at a retail sales facility, the system comprising:
means for scanning, via an electronic scanning device, identifying indicia of a plurality of products stored at the retail sales facility;
means for determining, via an electronic inventory management device including a processor and based on at least electronic data obtained during the scanning step, a physical size of each of the scanned products and a sequential order of the scanning of the products; and
means for estimating, using the electronic inventory management device, based on at least a correlation of the physical size of each of the scanned products and the sequential order of the scanning of the products, a physical location of the scanned products relative to one another.
